(19) United States
(12) Patent Application Publication
(10) Pub. No.: US 2009/0224681 A1
(43) Pub. Date: Sep. 10, 2009

(54) Hybrid Solar Powered and Grid Powered Lighting System

(75) Inventors: Stan Bassford, Bend, OR (US); Glenn Bateman, Bend, OR (US)

Correspondence Address: HANCOCK HUGHEY LLP, P.O. BOX 1208, SISTERS, OR, 97759, US

(73) Assignee: S & A Solar Technologies, Inc., Bend, OR (US)

(21) Appl. No.: 12/400,069

(22) Filed: Mar. 9, 2009

Related U.S. Application Data
(60) Provisional application No. 61/068,837, filed on Mar. 10, 2008.

(51) Int. Cl. H05B 37/00

(52) U.S. Cl. 315/176; 315/86

(57) ABSTRACT

A hybrid lamp assembly according to the present invention comprises several different primary components, specifically, a lamp, lamp housing, and controller. The lamp may be powered by either of two different alternative power sources, a solar panel and grid power, and a combination of power from the solar panel and the grid power. An indicator lamp houses two LEDs that indicate the status of the lamp and which power sources are providing current to the lamp, and the relative amount of current being supplied. The hybrid lamp assembly may optionally include an emergency backup battery system to power the lamp when no grid power is available.

### FIELD OF THE INVENTION

This invention relates to lighting systems, and more particularly to a lighting system that may be powered at any given time by different power sources, including solar power and grid power, and combinations of power from both of these power sources. The lighting system may optionally be configured to include an emergency battery backup power system.

### BACKGROUND AND SUMMARY OF THE INVENTION

There are innumerable commercially available lighting systems that are powered by electricity generated from solar panels, battery systems and grid power sources. Nonetheless, there is an ongoing need for new lighting systems that are operable from different power sources. The present invention is a hybrid lighting system in which a lamp may be alternately powered by electricity originating from a solar panel and conventional grid electric power. The system is configured to utilize power from both the solar power source and the grid power source; depending upon the amount of power available from the solar panel, additional power may be supplied from the grid power source. In one alternative embodiment, the system may include an optional emergency battery backup power source that powers the lamp.

The hybrid lighting system according to the present invention may be used in any setting where grid power is available, but is particularly useful where the alternate solar power sources can offer flexibility in how the lamp is powered. The circuitry is configured so that when grid power is available, the lamp may be powered solely by the solar panel, by combined power from both the solar panel and the grid, or from the grid alone. The circuitry minimizes any “flicker” in the lamp when the power sources change or when the proportion of power from one source relative to another changes, to the point where the flicker is not readily visible.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a schematic view of a hybrid lighting system according to the present invention, showing plural lamps, each with a lamp housing, a solar panel, emergency battery backup, grid power supply, the controller and other components.

FIG. 2 is a flow chart showing operation of the hybrid lighting system according to the present invention in various modes and with different power sources.

FIG. 3 is an exemplary circuit diagram illustrating wiring for a first embodiment of a hybrid lighting system according to the present invention.

### DETAILED DESCRIPTION OF THE PREFERRED AND ILLUSTRATED EMBODIMENTS

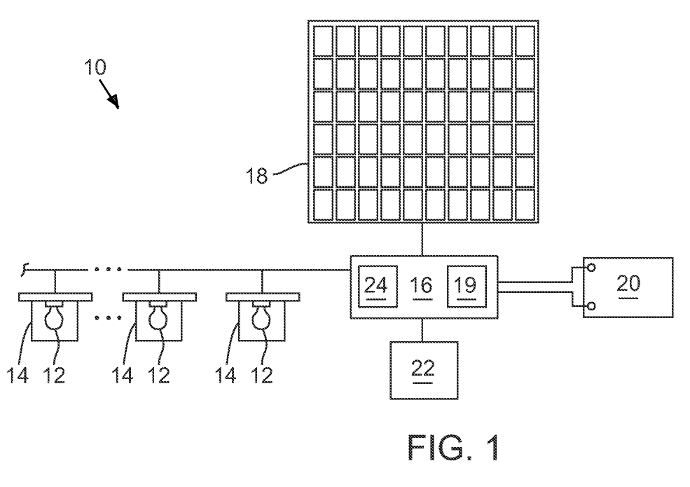

One possible arrangement of the components of a hybrid lamp assembly 10 according to the present invention is shown in the FIG. 1. Hybrid lamp 10 comprises several different primary components, specifically, one or more lamps 12, with each lamp 12 preferably contained in a lamp housing 14, a controller 16, and the three alternative power sources, namely solar panel 18, battery backup 20, which as detailed below is optional and when included is used in emergency situations when grid power is not available, and grid power 22 (represented by the block shown in the figure). Each of these components is described in detail below. It will be appreciated that the design configuration of the components may vary widely from those shown in the figures, and the figures should on that basis be taken as exemplary but not limiting in any manner.

The hybrid lamp 10 is preferably a low-voltage lighting system with power for illuminating the lamps 12 provided from three alternative power sources: (a) power from the grid power 22, which is standard AC line power; (b) power from the solar panel power supply, which is DC; and optionally, (c) power from the emergency battery backup, which is DC.

Hybrid lamp assembly 10 is configured so that the light switch 19, which is electrically connected in a conventional manner to controller 16, powers and thus illuminates lamp 12 regardless of the status of the sun. Stated another way, the circuitry in controller 16 is configured so that power is supplied to lamp 12 when the circuit defined by the light switch is closed without regard to whether power is being supplied by solar panel 18. The lamp assembly 10 is operable in several operational modes relating to power supply. The first mode is when grid power is available. In this mode, if there is enough power being generated by the solar panel 18 to fully illuminate the lamp(s) 12, then no grid power is used and only power from the solar panel is utilized. If there is not enough current being delivered from the solar panel 18, for instance during the evening hours or otherwise depending on sun position and cloud cover, if additional current is required to power lamp 12, the additional power is supplied by the grid power 22. The controller determines the amount of current available from the solar panel 18 and then obtains any additional power needed to illuminate lamps 12 from the grid. If there is no power being generated by the solar panel 18, for example at night, the lamps are illuminated only by power from the grid.

In a preferred embodiment, and as detailed below, the circuitry provided in controller 16 allows lamp 12 to be powered in the first mode with a combination of power from solar panel 18 and grid power 22. Thus, the power supply for lamp 12 is principally supplied in its entirely by either solar panel 18 when the solar panel is generating enough power for the lamp, or grid power 22 only when no power is available from solar panel 18, or a combination of power from the solar panel and grid when not enough power is available from the solar panel. As noted, if the grid power 22 is not available, the lamp 12 cannot be powered from solar panel 18.

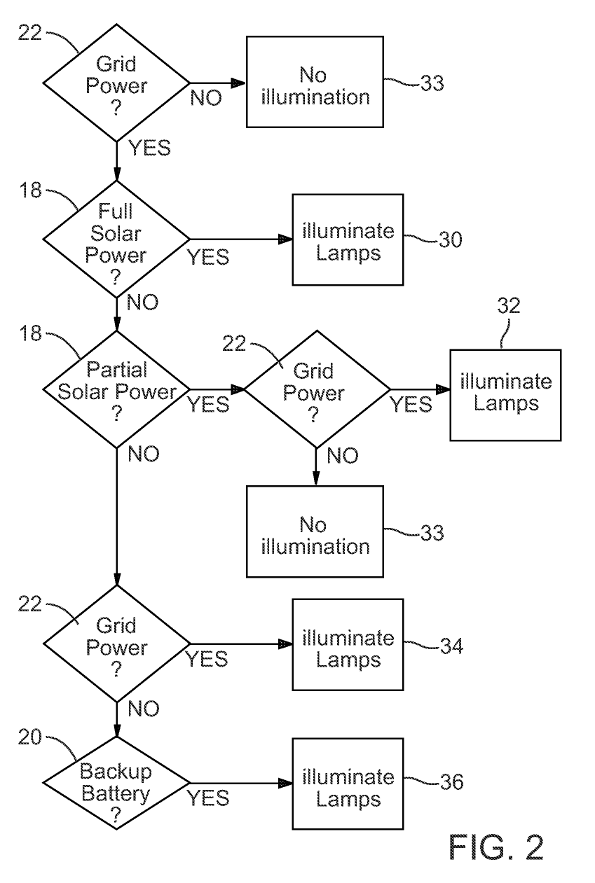

The variable power arrangement for powering a lamp 12 is shown in the flow chart of FIG. 2. If grid power 22 is available and there is sufficient power from solar panel 18 to fully power lamp 12 (or lamps 12), the lamp is illuminated (shown in the flow chart with reference number 30) solely with power from the solar panel 18. If there is no grid power 22, then the lamp will not be illuminated (shown in the flow chart with reference number 33) even if solar power is available. If there is power from solar panel 18, but not enough to fully power lamps 12, and if there is also power from grid 22, then the lamps are illuminated with a combination of power supplied from both solar panel 18 and grid 22 (reference number 32). If there is no power available from solar panel 18, but power is available from grid 22, lamps 12 are powered solely from the grid power source (reference number 34).

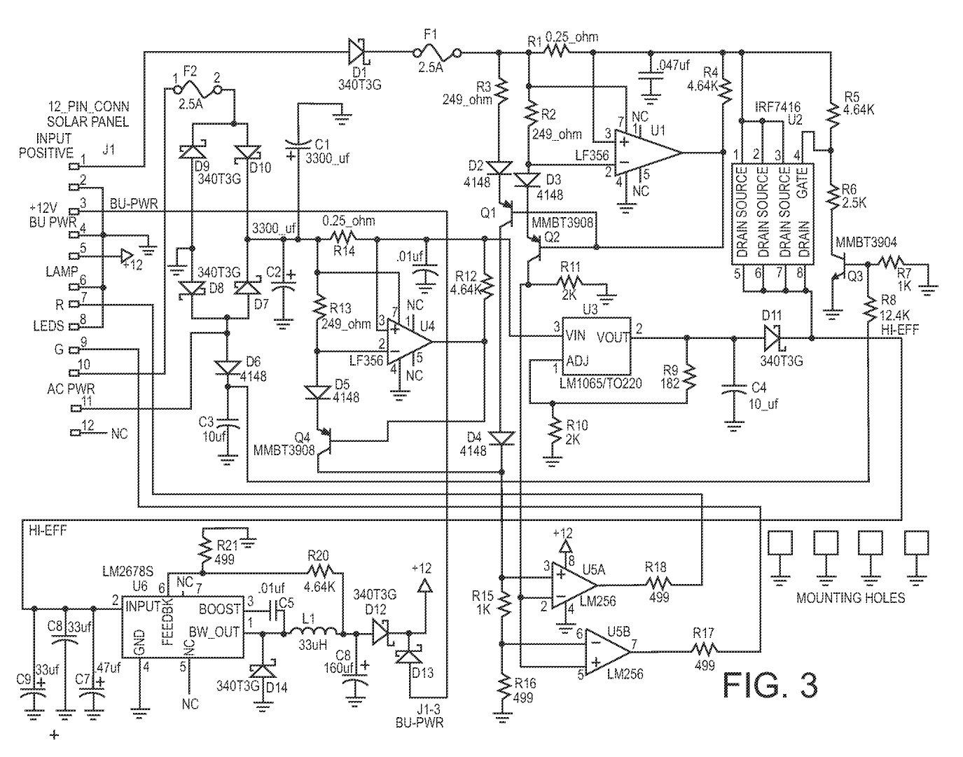

Hybrid lamp assembly 10 includes an indicator 24 that provides a quick visual indication of which power source (i.e., solar panel 18 or grid power 22, or both) is powering lamp 12 and the relative proportion of power being supplied from solar panel 18 and grid power 22. As shown in FIG. 1, indicator 24 is preferably closely associated with the controller 16 and switch 19. Although there are many different kinds of indicators that will suffice, the preferred indicator 24 has a single lamp LED that has 2 colored light emitting diodes (LED) in an array (see, e.g., the circuit diagram of FIG. 3) mounted in a convenient and observable position, for example on the controller 16 adjacent the light switch, or on the lamp housing 14. The color that the indicator lamp is glowing at any particular time when the lamp assembly 10 is in operation provides an indication of the approximate percentage of solar power to the total power being used to illuminate lamp 12. For example, the LEDs in indicator 24 are preferably red and green. With such an indicator, when only the red LED is illuminated the indicator is red. When only the green LED is illuminated the indicator glows green. When both the red and the green LEDs are illuminated the indicator glows yellow.

Continuing with this example, when only the red LED is illuminated and the indicator is thus red, it would indicate that the power from solar panel 18 is providing from about 0 to 25% of the total power being used to power lamp 12—the balance of the power for lamp 12 is supplied by grid power 22. When the indicator glows yellow—that is, when both the red and green LEDs are lit, the power from solar panel 18 is from about 25 to 75% of the total power. And when only the green LED is illuminated and the indicator is thus glowing green, the power from solar panel 18 is providing from about 75 to 100% of the total power required to illuminate the lamp 12—the balance of necessary power being supplied by grid power 22.

Turning now to the circuit diagram of FIG. 3, the primary power supply to lamp 12 is regulated to +15 volts DC, and is then combined with the power supplied by solar panel 18 and connected to the high-efficiency (hi-eff) regulated supply, which is set to +12 volts DC to power the lamp 12. The lamp 12 requires 1 to 2 ampere, depending on the wattage of the particular lamp being used. It will be appreciated that the “primary” power supply based on this circuit configuration is the grid power 22 because grid power is used to make up any deficiency in power supplied by solar panel 18.

The primary supply can be configured for 120/240 volts. The primary and secondary power supplies, including the battery backup power, may be designed to operate at other voltages depending upon the lamps, such as 24 volts.

The transformer's (refer to the circuit diagram of FIG. 3) output is 14 volts RMS, driving a full-wave-bridge rectifier followed by filter capacitors and through a 0.25 ohm current-sense resistor (R14) to a +15 volt 3-terminal regulator coupled by a diode (D11) to the hi-eff supply. D11 permits the solar panel voltage to rise above +15 volts.

In operation, solar-generated current flows from solar panel 18 through diode (D1) to a 0.25 ohm current sense resistor (R1) to a mosfet (U2) to the hi-eff supply. The mosfet (U2) has to turn off faster than the primary supply. Connecting to the transformer secondary, diode (D6) rectifies its output, which is then filtered by capacitor (C3) connected by resistors R7 and R8 to the base of transistor (Q3) to turn off the mosfet. This provides a faster turn off preventing light flicker when turning off the primary supply. D1 protects the solar panel from the +15 volts at low light levels.

The hi-eff supply utilizes a 5 amp step-down voltage regulator (U6). The two input capacitors (c8, c9) are very low-series resistance to supply the high current at regulator turn on. The inductor transfers its energy to the output at (U6) turn off through diodes D12 and D14. C6 (180 uf) capacitor stores the energy and reduces the ripple at the output. C5 (0.01 uf) capacitor feeds back to boost the gate drive to the internal mosfet in U6. Resistors (R20, R21) form a voltage divider to set the output at +12 volts.

When emergency backup power is supplied from backup battery 20, D12 isolates it from the hi-eff supply; D13 prevents feed back from the +12 volts to the backup power.

There are two current sense circuits to control the LED indicator described above. Op-amp U4 equalizes the voltage across R13 (249 ohm) with the voltage across R14 (0.25 ohm) sense resistor. This gives a current through Q4 that represents the current supplied by the primary power supply. This current is added to the current from Q1 that represents the current supplied by the solar panel 18. The sum of the two currents from Q4 and Q1 represents the total current the lamp 12 is using. This current generates the reference voltage across R16 and R15 to set the 25 and 75% solar-current levels represented by the red and green LED. The current from Q2 represents the solar current and is applied to R11, generating a voltage that is compared to the referenced voltage by op-amps Q5a and Q5b. Q5a drives the red LED and Q5b drives the green LED. For example, when solar current powering lamp 12 is from 0% to about 25%, the red is lit. When solar power is from about 75% to 100% of the total power required to illuminate lamp 12, the green LED is on. And as detailed above, when solar power from panel 18 is providing between about 25 to 75% of the total power, both the red and green LEDs are lit and the indicator lamp glows yellow.

As indicated previously, the invention may be optionally configured to operate in a second mode. The second mode occurs when grid power is unavailable, for example when the utility grid is down. In this mode, which is an optional backup operational mode, lamps 12 are illuminated only with power from backup battery 20 (which could be any external 12 volt power source). In the second mode the system will not utilize power from the solar panel 18 even if it is generating power. If the lamp assembly 10 includes a backup battery 20, the power source from the battery may be activated by either a manual switch or by an automatic relay that activates when grid power 22 is unavailable. With returning reference to the flow chart of FIG. 2, if lamp assembly 10 includes an emergency backup battery 20 and if there is no power available from grid 22, then lamps 12 are fully powered solely from backup battery 20 (reference number 36).

While the present invention has been described in terms of a preferred embodiment, it will be appreciated by one of ordinary skill that the spirit and scope of the invention is not limited to those embodiments, but extend to the various modifications and equivalents as defined in the appended claims.

1. A lamp system comprising:
a lamp,
a first power source for the lamp;
a second power source for the lamp;
a controller configured for illuminating the lamp from either the first power source, or a combination of power from the first and second power source, the proportion of power from the first power source relative to the proportion of power from the second power source determined by the level of power available from the first power source.

2. The lamp system according to claim 1 wherein the first power source is a solar panel.

3. The lamp system according to claim 1 wherein the second power source is grid power.

4. The lamp system according to claim 1 wherein the controller is configured operating in a first mode for illuminating the lamp solely from power from the first power source if the amount of power from the first power source is sufficient and power from the second power source is available.

5. The lamp system according to claim 4 wherein the controller is configured for operating in the first mode for illuminating the lamp with power from the first and second power sources if the amount of power from the first power source is insufficient to fully illuminate the lamp, and wherein in the first mode the controller combines power from the second power source with power available from the first power source to illuminate the lamp.

6. The lamp system according to claim 5 wherein the controller is operable in the first mode for illuminating the lamp with power from only the second power source if there is no power available from the first power source and there is power available from the second power source.

7. The lamp system according to claim 1 including a third power source.

8. The lamp system according to claim 7 wherein the third power source is a battery or any 12 volt power source.

9. The lamp system according to claim 8 operable in a second mode when there is no power available from the second power source, and wherein in the second mode the lamp may be illuminated with power only from the third power source.

10. The lamp system according to claim 1 including an indicator for indicating which of the first and second power sources are being utilized to illuminate the lamp and for indicating the relative proportion of power being supplied to the lamp by the first and second power sources.

11. The lamp system according to claim 10 wherein the indicator is a plurality of LED lamps.

12. A lamp system comprising:
a lamp,
a solar panel defining a first power source;
a grid power source defining a second power source;
a controller electrically connected to each of the first and second power sources and capable of powering the lamp in a first mode defined when power is available from the second power source, and wherein in the first mode the lamp may be illuminated by:
(a) power solely from the first power source;
(b) power from both the first and second power sources; and
(c) power solely from the second power source; and
wherein when the lamp is powered from both the first and second power sources, the controller determines the proportion of power from the first power source relative to the total combined power from the first and second power sources and provides a visual indication of said proportion of power.

13. The lamp system according to claim 12 configured for operating in a second mode, said second mode defined when there is no power available from the second source, and wherein in said second mode the lamp is powered by a third power source.

14. The lamp system according to claim 12 wherein the visual indication of said proportion of power is defined by an indicator for indicating which of the first and second power sources are illuminating the lamp and for indicating the relative proportion of power being supplied to the lamp by the first power source.

15. The lamp system according to claim 14 wherein the indicator is defined by a plurality of LED lamps.

16. A method of powering a lamp system, comprising the steps of:
(a) providing a lamp;
(b) connecting the lamp to a controller;
(c) connecting a first power source to the controller;
(d) connecting a second power source to the controller; and
(e) determining whether power is available from the second power source and if power is available from the second power source, determining the amount of power available from the first power source, and if the amount of power from the first power source is sufficient to illuminate the lamp, illuminating the lamp solely from the first power source, and if the amount of power from the first power source is insufficient to illuminate the lamp, illuminating the lamp with a combination of power from first and second power sources.

17. The method of claim 16 including the step of connecting a third power source to the lamp.

18. The method of claim 17 including operating the lamp system to illuminate the lamp with power from the third power source only if power from the second power source is unavailable.

19. The method of claim 16 wherein the first power source is a solar panel.

20. The method of claim 16 wherein the second power source is grid power.
